(19) United States
(12) Patent Application Publication
(10) Pub. No.: US 2010/0042844 A1
(43) Pub. Date: Feb. 18, 2010

(54) METHOD, BASE STATION, RELAY STATION AND RELAY COMMUNICATION SYSTEM FOR IMPLEMENTING MESSAGE AUTHENTICATION

(76) Inventors: Guohui ZOU, Shenzhen (CN); Yan Peng, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/582,951

(22) Filed: Oct. 21, 2009

Related U.S. Application Data
(63) Continuation of application No. PCT/CN2008/070828, filed on Apr. 28, 2008.

(30) Foreign Application Priority Data
Apr. 28, 2007 (CN) 200710097229.1

(51) Int. Cl. H04L 9/32; H04L 9/08; H04L 9/00

(52) U.S. Cl. 713/176; 380/278; 380/44

(57) ABSTRACT

A method for implementing message authentication is provided. The method includes the following steps. A path by which a destination address of a message to be sent can be reached is determined. A signature processing is performed on the message to be sent according to a private key corresponding to the path, so as to obtain an authentication code. The message to be sent and the authentication code are sent through the path.

### CROSS-REFERENCE TO RELATED APPLICATION

This present application is a continuation of International Application No. PCT/CN 2008/070828 filed on Apr. 28, 2008, which claims the priority to Chinese patent application No. 200710097229.1, filed on Apr. 28, 2007, and entitled “METHOD, BASE STATION, RELAY STATION AND RELAY COMMUNICATION SYSTEM FOR IMPLEMENTING MESSAGE AUTHENTICATION”, the contents of both of which are incorporated herein by reference in their entirety.

### FIELD OF THE TECHNOLOGY

The present disclosure relates to a communication technology, and more particularly to a method, a base station (BS), a relay station (RS), and a relay communication system for implementing message authentication.

### TECHNICAL BACKGROUND

In a wireless communication system, due to the path attenuation of electromagnetic waves and the obstruction of buildings, wireless communication signals have low intensities in some areas. Accordingly, the communication quality of the mobile terminals in such areas is deteriorated. On the other hand, with the people's increasingly high demands for wideband wireless communication, the demands for wireless bandwidth become increasingly large. Therefore, higher and higher carrier frequencies are adopted in new protocols and systems. Moreover, the attenuation of radio waves will increase as the frequency increases, so that a high attenuation problem definitely occurs for the high carrier frequency, which further limits the coverage of a BS. In order to enable the BS to have a larger coverage, an RS is usually required to enhance wireless communication signals between the BS and a mobile station (MS). Generally speaking, a system having at least one RS is referred to as a multi-hop relay communication system. FIG. 1 is a schematic view of a multi-hop relay communication system. Each RS in FIG. 1 is in charge of forwarding messages between a BS and an MS (for example, an MS1 may be covered by an RS6, and messages may be transmitted between the MS1 and the BS through a path formed by RS1, RS3, and RS6).

During message forwarding, each RS on the path may need to authenticate the received message, so as to confirm authenticity and completeness of the message. That is, to verify whether the received message comes from a real sender (that is, a BS) and is not modified. Only after the message passes the verification, the RS will perform corresponding operations. In order to implement the message authentication, a signature technology needs to be employed for processing the message. The signature technology may employ a symmetric signature technology and/or an asymmetric signature technology.

In the symmetric signature technology, a receiver and a sender share one symmetric key. A key used for generating a signature is the same as that used for verifying the signature. Alternatively, although the key used for generating the signature is different from that used for verifying the signature, one key may be derived from the other. Major features of the technology include that a public algorithm is adopted; the security depends on the protection of the keys; and the identity authentication fails to be implemented.

In the asymmetric signature technology, a receiver and a sender need two keys. That is, a public key and a private key. The public key and the private key have a corresponding relation. If the private key is adapted to generate a signature of a message, only the corresponding public key can be adapted to verify the signature. In addition, although the two keys have a certain corresponding relation, one key cannot be derived from the other. Therefore, even if one of the two keys is made public, the confidentiality of the other key is not affected.

In the relay communication system, message authentication is usually performed through the symmetric signature technology in the prior art. The message authentication includes the following steps. Each RS is configured to share one symmetric key with a BS respectively. When the BS needs to send a message, corresponding to each RS on the whole link, a signature processing is performed on the message to be sent through the corresponding key shared with the RS, so as to generate an authentication code corresponding to the key. Subsequently, the message and all the generated authentication codes are sent together. After a first level RS in the link receives the message and the authentication codes, the message is verified by using the received authentication code corresponding to the first level RS itself. If the verification is successful, the authentication code used in the verification is deleted. Then, the message and the other authentication codes are sent to a lower level RS. After receiving the message and the authentication codes sent from the upper level RS, the lower level RS continues to verify the received message by using the received authentication code corresponding to the lower level RS itself. If the verification is successful, the authentication code used in the verification is deleted. The message and the other authentication codes continue to be delivered to an even lower level station, and so forth. Similar processing is performed repeatedly, until the message is sent to a destination station.

The message verification by using the authentication code is implemented through the following manner. Each RS performs the same signature processing on the received message through the key shared with the BS, so as to obtain an object code. The received authentication code corresponding to the RS is compared with the obtained object code. If the two are the same, the message verification is confirmed to be successful.

The above solution enables each RS in the link to check whether the received message is modified or not. However, as the BS needs to calculate and send a corresponding authentication code for each RS in the link respectively, if too many RSs exist in one link, the calculation of the BS is rather intensive. Moreover, a lot of authentication codes need to be sent, so that a great amount of air interface resources may be correspondingly occupied.

In the prior art, another method for implementing message authentication in a multi-hop relay communication system is provided. The method includes the following steps. A BS classifies RSs in its coverage into several security domains and enables all the RSs on the same link to belong to the same security domain. Each security domain is configured to share one symmetric key with the BS respectively. All the RSs in the same security domain are configured with the same key. In such a manner, all the RSs on the same link are configured with the same key. When the BS needs to send a message, the signature processing is performed on the message to be sent through the key shared with all the RSs in the whole link, thereby generating an authentication code. Subsequently, the message and the generated authentication code are sent together. After a first level RS in the link receives the message and the authentication code, the message is verified by using the authentication code. If the verification is successful, the message and the authentication code continue to be sent to a lower level RS. After receiving the message and the authentication code sent by the upper level RS, the lower level RS continues to verify the message by using the authentication code. If the verification is successful, the message and the authentication code continue to be delivered to an even lower level station, and so forth. Similar processing is performed repeatedly, until the message is sent to a destination station.

The message verification by using the authentication code is implemented through the following manner. Each RS performs the same signature processing on the received message through the key shared with the BS, so as to obtain an object code. The received authentication code and the obtained object code are compared. If the two are the same, the verification of the received message is confirmed to be successful.

In the above solution, as all the RSs on the same link are configured with the same key, the BS only needs to generate and send one message authentication code. In such a manner, the BS does not need to perform calculations for different RSs respectively, and further saves the air interface resources occupied for sending messages. However, if a certain RS on the link modifies the message and also modifies the authentication code correspondingly and then sends them to a lower level RS, the lower level RS may fail to find out such modification. Moreover, if one key in the RS is cracked, the whole corresponding security domain may be affected. Thus, the solution has a low security level.

### SUMMARY

Accordingly, embodiments of the present disclosure are directed to a method for implementing message authentication and a corresponding BS, RS, and relay communication system, so as to save air interface resources occupied for sending messages, and increase security of message authentication.

Embodiments of the present disclosure provide the following technical solutions.

A method for implementing message authentication is provided, which includes the following steps.

A path by which a destination address of a message to be sent can be reached is determined.

A signature processing is performed on the message to be sent according to a private key corresponding to the path, so as to obtain an authentication code.

The message to be sent and the authentication code are sent through the path.

A BS is provided, which includes a path obtaining unit, an authentication code obtaining unit, and a sending unit.

The path obtaining unit is configured to determine a path by which a destination address of a message to be sent can be reached.

The authentication code obtaining unit is configured to perform a signature processing on the message to be sent according to a private key corresponding to the determined path, so as to obtain an authentication code.

The sending unit is configured to send the message to be sent and the authentication code through the path.

An RS is provided, which includes a receiving unit and a message authentication unit.

The receiving unit is configured to receive a message and an authentication code.

The message authentication unit is configured to perform signature verification on the authentication code according to a public key corresponding to a path for transmitting the message, and authenticate the message according to a result of the signature verification.

A relay communication system is provided, which includes a BS and at least one RS.

The BS is configured to determine a path by which a destination address of a message to be sent can be reached, perform a signature processing on the message to be sent according to a private key corresponding to the determined path to obtain an authentication code, and send the message to be sent and the authentication code through the path.

The RS is configured to receive the message and the authentication code, perform signature verification on the authentication code according to a public key corresponding to the path, and authenticate the message according to a result of the signature verification.

The embodiments of the present disclosure have the following advantages. If a public key of an RS is obtained by a malicious third party, a corresponding private key cannot be derived from the public key, and the private key is only carried by a BS, so that the malicious third party still cannot obtain the private key. On the other hand, when the RS authenticates the received message according to its own public key and the received authentication code, if the received authentication code is not generated by the real private key, the authentication on the received message cannot be successful. Therefore, as compared with the message authentication using a symmetric key in the prior art, the embodiments of the present disclosure achieve a higher security. Moreover, as all the RSs on the same link are configured with public keys corresponding to the same private key, as for a message to be sent, the BS only needs to generate and send one authentication code. In such a manner, the BS does not need to perform calculations for each RS on the link respectively. Therefore, a small amount of calculations are required. Meanwhile, the air interface resources occupied for sending messages are also saved.

### BRIEF DESCRIPTION OF THE DRAWINGS

FIG. 1 is a schematic view of a multi-hop relay communication system in the prior art;

FIG. 2 is a flow chart of a method for implementing message authentication according to Embodiment One of the present disclosure;

FIG. 3 is a structural view of a BS according to Embodiment Five of the present disclosure; and

FIG. 4 is a structural view of an RS according to Embodiment Nine of the present disclosure.

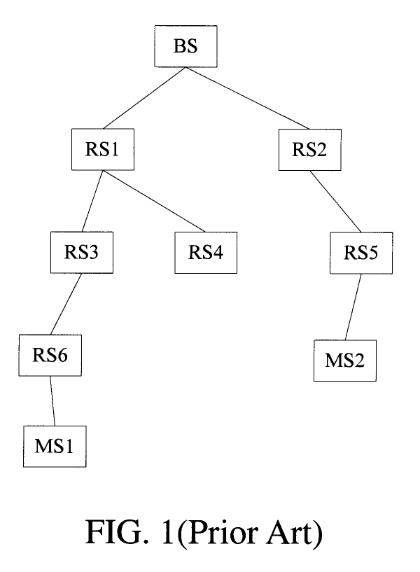

### DETAILED DESCRIPTION OF THE EMBODIMENTS

Embodiments of a method for implementing message authentication and a corresponding BS, RS, and relay communication system provided in the present disclosure are illustrated below in detail with reference to the accompanying drawings.

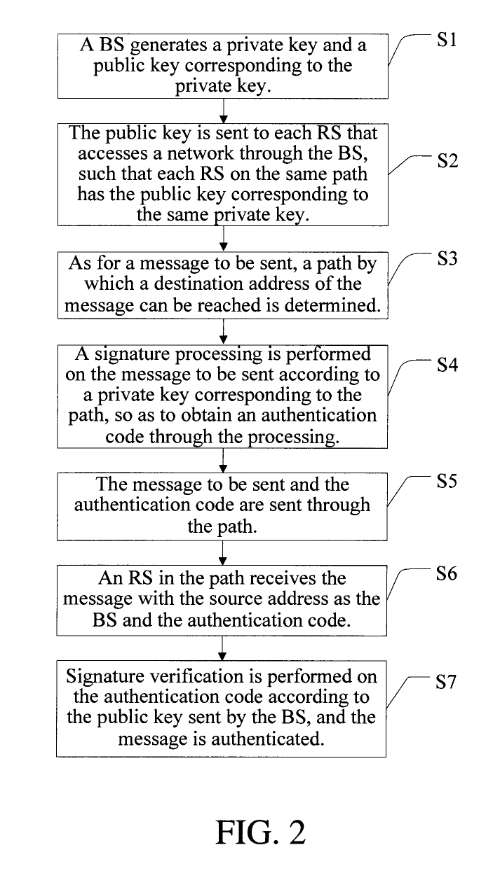

In Embodiment One, a method for implementing message authentication is provided. Referring to FIG. 2, the method includes the following steps.

In Step S1, a BS generates a private key and a public key corresponding to the private key.

The BS may only generate one private key, and a public key corresponding to the private key. Alternatively, the BS may generate at least two private keys, and public keys corresponding to each private key respectively.

A one-to-one corresponding relation or a one-to-multiple corresponding relation may exist between the private key and the public keys. That is, only one public key or a plurality of public keys may correspond to one private key.

In Step S2, the public key is sent to each RS that accesses a network through the BS, such that each RS on the same path has the public key corresponding to the same private key.

In Step S3, as for a message to be sent, a path by which a destination address of the message can be reached is determined.

In Step S4, a signature processing is performed on the message to be sent according to a private key corresponding to the determined path, and obtain an authentication code.

In Step S5, the message to be sent and the authentication code are sent through the path.

In Step S6, each RS in the path receives the message and the authentication code.

In Step S7, signature verification is performed on the authentication code according to the public key corresponding to the path that is already sent by the BS, and the message is authenticated according to a result of the signature verification.

In this embodiment, if the public key of the RS is obtained by a malicious third party, a corresponding private key cannot be derived from the public key, and the private key is only carried by the BS, so that the malicious third party still cannot obtain the private key. On the other hand, when the RS authenticates the received message according to its own public key and the received authentication code, if the received authentication code is not generated by the corresponding private key, the authentication on the received message cannot be successful. Therefore, this embodiment of the present disclosure achieves a higher security. Moreover, as all the RSs on the same link are configured with public keys corresponding to the same private key, the BS only needs to generate and send one authentication code. In such a manner, the BS does not need to perform calculations for each RS on the link respectively. Therefore, a small amount of calculations are required. Meanwhile, the air interface resources occupied for sending messages are also saved.

In Embodiment Two, a method for implementing message authentication is provided, which includes the following steps.

In Step P1, a BS generates one private key, and one public key corresponding to the private key.

In Step P2, the public key is sent to each RS that accesses a network through the BS.

When sending the public key to each RS that accesses the network, the BS may further encrypt the public key through a security relation agreed with the RS and then send the encrypted public key. After receiving the encrypted public key, the RS decrypts the received content and obtains the public key.

In Step P3, as for a message to be sent, a path by which a destination address of the message can be reached is determined.

In Step P4, a signature processing is performed on the message to be sent according to the private key, so as to obtain an authentication code.

The performing the signature processing on the message to be sent according to the private key to obtain the authentication code may specifically includes performing calculations through a preset asymmetric signature algorithm by taking the private key and the message to be sent as the input to obtain the authentication code.

The asymmetric signature algorithm may be Rirest, Sllalnlr, and Adleman (RSA) algorithm or Diffie-Hellman algorithm, and the like.

In Step P5, the message and the authentication code are sent together.

In Step P6, after a first level RS in the link receives the downlink message and the authentication code, signature verification is performed on the authentication code according to the public key already sent by the BS. The message is authenticated according to a processing result of the signature verification. If the authentication is successful, the message and the authentication code continue to be sent to a lower level RS.

In Step P7, after the lower level RS receives the downlink message and the authentication code, signature verification continues to be performed on the authentication code according to the public key already sent by the BS. The message is authenticated according to a processing result of the signature verification. If the authentication is successful, the message and the authentication code continue to be sent to an even lower level station, and so forth. Similar processing is performed repeatedly, until the message is sent to a destination station.

Corresponding to the above signature processing method, the performing the signature verification on the authentication code according to the public key already sent by the BS and authenticating the message according to the obtained processing result of the signature verification in Step P6 and Step P7 may specifically include the following manners.

Calculations are performed through an asymmetric signature verification algorithm corresponding to the signature algorithm by taking the public key already sent by the BS and the authentication code as the input, so as to obtain an object code word.

It is determined whether the object code word and the message are the same or not. If yes, the message authentication is successful; otherwise, the authentication fails.

In this embodiment, the BS only generates one private key, and one public key corresponding to the private key. Therefore, the same public key is sent to all the RSs that access the network, which is quite simple in implementation.

In Embodiment Three, a method for implementing message authentication is provided. This embodiment and Embodiment Two are almost the same. The difference there-between lies in changes made to Step P1 and Step P2 as follows.

In Step P1a, a BS generates one private key and at least two public keys corresponding to the private key.

In Step P2a, the generated public keys are respectively assigned for each RS that accesses a network through the BS, such that at least two RSs in the same path have different public keys. Alternatively, the RSs on at least two different paths have different public keys. The assigned public keys are sent to the RSs.

In Embodiment Four, a method for implementing message authentication is provided, which includes the following steps.

In Step N1, a BS generates at least two private keys and public keys corresponding to the at least two private keys respectively.

In Step N2, the generated public keys are respectively assigned for each RS that accesses a network through the BS, such that the public keys assigned to the RSs on the same path correspond to the same private key, and at least two different paths correspond to different private keys.

In Step N3, the assigned public keys are sent to the RSs.

When sending the public key to each RS that accesses the network, the BS may further encrypt the public key first through a security relation agreed with the corresponding RS and then send the encrypted public key. After receiving the encrypted public key, the RS decrypts the received content, so as to obtain the public key.

In Step N4, as for a message to be sent, a path by which a destination address of the message can be reached is determined.

In Step N5, a private key corresponding to the path is determined according to a corresponding relation between private keys preset in the BS and the paths, and a signature processing is performed on the message to be sent according to the private key, so as to obtain an authentication code.

The performing the signature processing on the message to be sent according to the private key and obtaining the authentication code may specifically include: performing calculations through an asymmetric signature algorithm by taking the private key corresponding to the determined path and the message to be sent as the input, so as to obtain the authentication code.

In Step N6, the message and the authentication code are sent together.

In Step N7, after a first level RS in the link receives the downlink message and the authentication code, signature verification is performed on the authentication code according to the public key already sent by the BS, and the message is authenticated according to a processing result of the signature verification. If the authentication is successful, the message and the authentication code continue to be sent to a lower level RS.

In Step N8, after the lower level RS receives the downlink message and the authentication code, signature processing continues to be performed on the authentication code according to the public key already sent by the BS, and the message is authenticated according to a processing result of the signature processing. If the authentication is successful, the message and the authentication code continue to be sent to an even lower level station, and so forth. Similar processing is performed repeatedly, until the message is sent to the destination station.

Corresponding to the above signature processing method, the performing the signature processing on the authentication code according to the public key sent by the BS and the authenticating the message according to the processing result in Step N7 and Step N8 may specifically include the following manner.

Calculations are performed through an asymmetric signature verification algorithm corresponding to the signature algorithm by taking the public key already sent by the BS and the authentication code as the input, and an object code word is obtained from the calculations.

It is determined whether the object code word and the received message are the same or not. If yes, the authentication on the received message is successful; otherwise, the authentication fails.

In this embodiment, the BS generates at least two private keys, and public keys corresponding to the at least two private keys respectively. When the generated public keys are distributed to RSs that access the network, the RSs on the same path are assigned with public keys corresponding to the same private key, and the RSs on at least two different paths are assigned with public keys corresponding to different private keys. In such a manner, if one private key is cracked, only security domains using the private key are affected. The confidentiality of the security domains using the other private key still can be guaranteed. Compared with the BS using only one private key, a higher security is achieved.

In alternative embodiments of the present disclosure, the private key and the public key may also be configured into the BS and the RSs respectively in other manners.

In alternative embodiments of the present disclosure, the performing the signature processing on the message to be sent according to the private key to obtain the authentication code may include the following manner.

The message to be sent is processed according to a hash algorithm, so as to obtain a hash value.

A hash value in predetermined digits is retrieved from the obtained hash value according to a preset rule.

Calculations are performed through an asymmetric signature algorithm by taking the private key corresponding to the determined path and the retrieved hash value in the predetermined digits as the input, and the authentication code is obtained through calculations.

Correspondingly, the performing the signature verification on the authentication code according to the public key preset in the RS corresponding to the path and the authenticating the message according to a processing result may also include the following manner.

The message is processed according to the hash algorithm, so as to obtain a hash value corresponding to the message.

The predetermined digits are retrieved from the obtained hash value according to the preset rule.

Calculations are performed through an asymmetric signature verification algorithm corresponding to the signature algorithm by taking the public key preset in the RS corresponding to the path and the retrieved hash value in the predetermined digits as the input, and an object code word is obtained.

It is determined whether the object code word and the authentication code are the same or not. If yes, the message authentication is successful; otherwise, the authentication fails.

The retrieving the predetermined digits from the obtained hash value may include retrieving first several digits or last several digits of the hash value obtained through the hash algorithm.

It is apparent to those of ordinary skill in the art that, all or a part of steps in the method of the above embodiments may be accomplished by relevant hardware that is instructed through a program. The program may be stored in a computer readable storage medium such as an ROM/RAM, a magnetic disk, and an optical disk.

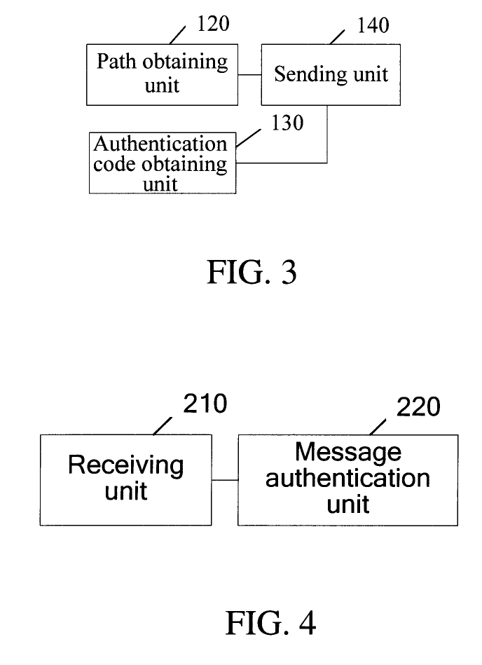

In Embodiment Five, a BS is provided. Referring to FIG. 3, the BS includes a path obtaining unit 120, an authentication code obtaining unit 130, and a sending unit 140.

The path obtaining unit 120 is configured to determine a path by which a destination address of a message to be sent can be reached.

The authentication code obtaining unit 130 is configured to perform a signature processing on the message to be sent according to a private key corresponding to the determined path, so as to obtain an authentication code through the processing.

The sending unit 140 is configured to send the message to be sent and the authentication code through the path.

In Embodiment Six, a BS is provided. The BS in this embodiment is similar to the BS in Embodiment Five. The main difference there-between is that, the authentication code obtaining unit in this embodiment specifically includes a hash processing unit, a retrieving unit, and a calculating unit.

The hash processing unit is configured to process the message to be sent according to a hash algorithm, so as to obtain a hash value. The retrieving unit is configured to retrieve a hash value in predetermined digits from the hash value obtained through the hash processing according to a preset rule. The calculating unit is configured to perform calculations through an asymmetric signature algorithm by taking the private key corresponding to the determined path and the retrieved hash value in the predetermined digits as the input, so as to obtain the authentication code.

In Embodiment Seven, a BS is provided. The BS in this embodiment is similar to the BS in Embodiment Five or Embodiment Six, and the main difference there-between is that, the BS in this embodiment further includes a key generating unit and a key sending unit. The key generating unit is configured to generate a private key, and a public key corresponding to the private key. The key sending unit is configured to send the generated public key to each RS that accesses the network.

In Embodiment Eight, a BS is provided. The BS in this embodiment is similar to the BS in the Embodiment Five or Embodiment Six. The main difference there-between is that, the BS in this embodiment further includes a key generating unit, a key sending unit, and an assigning unit. The key generating unit is configured to generate a private key and a public key corresponding to the private key. The assigning unit is configured to assign the generated public key for each RS that accesses a network through the BS, so as to enable the public key assigned to each RS on the same path to correspond to the same private key. The key sending unit is configured to send the assigned public key to each RS that accesses the network through the BS.

In Embodiment Nine, an RS is provided. Referring to FIG. 4, the RS includes a receiving unit 210 and a message authentication unit 220.

The receiving unit 210 is configured to receive a message and an authentication code.

The message authentication unit 220 is configured to perform signature verification on the authentication code according to a public key corresponding to a path for transmitting the message, and perform authentication on the message.

In Embodiment Ten, an RS is provided, which includes a receiving unit and a message authentication unit.

The receiving unit is configured to receive a message and an authentication code. The message authentication unit is configured to perform signature verification on the authentication code according to a public key corresponding to a path for transmitting the message, and perform authentication on the message. The message authentication unit specifically includes a hash processing unit, a retrieving unit, a calculating unit, and a determining unit.

The hash processing unit is configured to process the message according to a preset hash algorithm, so as to obtain a hash value.

The retrieving unit is configured to retrieve predetermined digits from the hash value obtained through the hash processing according to a preset rule.

The calculating unit is configured to perform calculations through an asymmetric signature verification algorithm corresponding to a BS where the path belongs to by taking the public key corresponding to the path for transmitting the message and the retrieved hash value in the predetermined digits as the input, so as to obtain an object code word.

The determining unit is configured to determine whether the object code word obtained by the calculating unit and the authentication code received by the receiving unit are the same or not. When the two are the same, a determination result that the authentication on the received message is successful is output. When the two are different, a determination result that the authentication on the received message fails is output.

In Embodiment Eleven, a relay communication system is provided, which includes a BS and at least one RS.

The BS is configured to determine a path by which a destination address of a message to be sent can be reached, perform a signature processing on the message to be sent according to a private key corresponding to the determined path, and obtain an authentication code through the processing, and send the message to be sent and the authentication code through the path.

The RS is configured to receive a message and an authentication code, perform signature verification on the authentication code according to a public key corresponding to the path, and authenticate the message.

In alternative embodiments of the present disclosure, the BS in the system may employ a structure of the BS in Embodiment Five, Embodiment Six, Embodiment Seven, or Embodiment Eight. The RS may employ a structure of the RS in Embodiment Nine or Embodiment Ten.

It should be noted that, the equipment or system according to the embodiments of the present disclosure may be implemented in a manner of hardware, or may also be implemented in a manner of a software function module.

In view of the above, in the embodiments of the present disclosure, if the public key of the RS is obtained by a malicious third party, as the corresponding private key cannot be derived from the public key, and the private key is carried by the BS, the malicious third party still cannot obtain the private key. On the other hand, when the RS performs authentication on the received message through its own public key and the received authentication code, if the received message authentication code is not generated through a corresponding private key, the authentication of the received message cannot be successful. Therefore, the embodiments of the present disclosure achieve a higher security. Moreover, as the RSs on the same link are configured with public keys corresponding to the same private key, as for a message to be sent, the BS only needs to generate and send one authentication code. In such a manner, the BS does not need to perform calculations for each RS on the link respectively. Therefore, a small amount of calculations are required. Meanwhile, the air interface resources occupied for sending messages are also saved.

In addition, if the BS only generates one private key and one public key corresponding to the private key, the same public key is sent to the RSs that access a network, which is rather simple in implementation.

If the BS generates at least two private keys and public keys corresponding to the at least two private keys respectively, when the generated public keys are sent to the RSs that access the network, the RSs on the same path are assigned with public keys corresponding to the same private key, and the RSs on at least two different paths are assigned with public keys corresponding to different private keys. In such a manner, if one private key is cracked, only security domains using the private key are affected. The confidentiality of the security domains using the other private key still can be guaranteed. Compared with the BS using only one private key, a higher security is achieved.

Through the above descriptions of the embodiments, it is apparent to those skilled in the art that, the present disclosure may be accomplished by software together with a necessary universal hardware platform, and definitely may also be completely accomplished by hardware. In most cases, the former is a preferred implementation manner. Therefore, all or a part of the disclosed embodiments of the present disclosure that makes contributions to the prior art can be substantially embodied in the form of a software product. The computer software product may be stored in a computer readable storage medium such as a ROM/RAM, a magnetic disk, or an optical disk, and contain several instructions to instruct a computer equipment (for example, a personal computer, a server, or network equipment) to perform the methods described in the embodiments of the present disclosure or in some parts of the embodiments of the present disclosure.

The method for implementing message authentication and the corresponding BS, RS and relay communication system provided in the embodiments of the present disclosure have been illustrated above in detail. Specific examples are described herein to illustrate principles and implementations of the present disclosure. The above illustrations of the embodiments are only intended to facilitate the understanding of the methods and ideas of the present disclosure. Meanwhile, those of ordinary skill in the art may make variations to the implementations and application scopes according to the ideas of the present disclosure. In view of the above, the contents of the specification should not be considered as limiting the present disclosure.

What is claimed is:

1. A method for implementing message authentication, comprising:
determining a path by which a destination address of a message to be sent can be reached;
processing a signature on the message to be sent according to a private key corresponding to the path;
obtaining an authentication code; and
sending the message to be sent and the authentication code through the path.

2. The method of claim 1, wherein the method further comprises:
receiving, by a Relay Station (RS), in the path, the message and the authentication code; and
performing, by the RS, a signature verification on the authentication code according to a public key corresponding to the path, and authenticating, the message according to a result of the signature verification.

3. The method of claim 2, wherein, before the step of determining a path by which a destination address of a message to be sent can be reached further comprises:
generating, the private key and a public key corresponding to the private key; and
sending, the public key to the RS.

4. The method of claim 3, wherein before the step of determining a path by which a destination address of a message to be sent can be reached further comprises:
assigning the generated public key for the RS.

5. The method of claim 3, wherein the generating the private key and a public key corresponding to the private key comprises:
generating one private key, and at least one public key corresponding to the private key.

6. The method of claim 4, wherein:
the generating the private key and a public key corresponding to the private key comprises:
generating at least two private keys, and a public key corresponding to the at least two private keys respectively; and
the assigning the generated public key for the RS comprises:
enabling the public keys assigned to the RS in the same path to correspond to one same private key, wherein at least two different paths are corresponding to the different private keys.

7. The method of claim 2, wherein the processing a signature on the message to be sent according to a private key corresponding to the path, and obtaining an authentication code comprises:
obtaining a hash value according to a preset hash algorithm processing the message to be sent;
retrieving a hash value in predetermined digits from the obtained hash value according to a preset rule; and
taking the private key corresponding to the determined path and the retrieved hash value in the predetermined digits as the input, and obtaining an authentication code through a calculation of an asymmetric signature algorithm.

8. The method of claim 7, wherein the performing, by the RS, a signature verification on the authentication code according to a public key corresponding to the path and authenticating the message according to a result of the signature verification comprises:
obtaining, by the RS, a hash value corresponding to the message according to a preset hash algorithm processing the message to be sent;
retrieving the hash value in predetermined digits from the obtained hash value according to the preset rule;
taking the public key preset in the RS corresponding to the path and the retrieved hash value in the predetermined digits as the input, and obtaining an object code word through calculations of an asymmetric signature verification algorithm corresponding to the signature algorithm; and
determining the message authentication is successful if the object code word and the authentication code are the same, otherwise, determining the message authentication fails.

9. A Base Station (BS) comprising:
a path obtaining unit configured to determine a path by which a destination address of a message to be sent can be reached;
an authentication code obtaining unit configured to perform a signature processing on the message to be sent according to a private key corresponding to the determined path, and obtain an authentication code; and
a sending unit configured to send the message to be sent and the authentication code through the path.

10. The BS of claim 9, comprising:
a key generating unit configured to generate a private key, and a public key corresponding to the private key; and
a key sending unit configured to send the generated public key to at least one Relay Station (RS) that accesses a network through the BS.

11. The BS of claim 9 further comprising:
a key generating unit configured to generate a private key and a public key corresponding to the private key;
an assigning unit configured to assign the generated public key by key generating unit for a RS, and enable the public key assigned to each RS on the same path to correspond to the same private key; and
a key sending unit configured to send the assigned public key by the assigning unit to the RS.

12. The BS of any one of claim 9, wherein the authentication code obtaining unit comprises:
a hash processing unit configured to process the message to be sent according to a hash algorithm, and obtain a hash value;
a retrieving unit configured to retrieve a hash value in predetermined digits from the hash value obtained through the hash processing according to a preset rule; and
a calculating unit configured to take the private key corresponding to the determined path and the retrieved hash value in the predetermined digits as the input, perform calculations through an asymmetric signature algorithm, and obtain the authentication code.

13. A Relay Station (RS) comprising:
a receiving unit configured to receive a message and an authentication code; and
a message authentication unit configured to perform signature verification on the authentication code according to a public key corresponding to a path for transmitting the message, and perform authentication on the message according to the result of signature verification.

14. The RS of claim 13, wherein the message authentication unit comprises:
a hash processing unit configured to process the message according to a preset hash algorithm, and obtain a hash value;
a retrieving unit configured to retrieve predetermined digits from the hash value obtained by the hash processing unit according to a preset rule;
a calculating unit configured to take the public key corresponding to the path for transmitting the message and the retrieved hash value in the predetermined digits by the retrieving unit as an input, perform calculations through an asymmetric signature verification algorithm corresponding to a Base Station (BS) where the path belongs to, and obtain an object code word; and
a determining unit configured to determine whether the object code word obtained by the calculating unit and the authentication code received by the receiving unit are the same or not, if the two are the same, output a determination result that the authentication on the received message is successful, and if the two are different, output a determination result that the authentication on the received message fails.

15. A relay communication system, comprising:
a Base Station (BS) configured to determine a path by which a destination address of a message to be sent can be reached, perform a signature processing on the message to be sent according to a private key corresponding to the determined path, obtain an authentication code, and send the message to be sent and the authentication code through the path; and
at least one Relay Station (RS) configured to receive the message and the authentication code, perform signature verification on the authentication code according to the public key corresponding to the path, and authenticate the message according to the result of signature verification.
